(19) United States
(12) Patent Application Publication
(10) Pub. No.: US 2008/0040772 A1
(43) Pub. Date: Feb. 14, 2008

(54) REMOVABLE APPARATUS WITH A PLUG-AND-SHOW FUNCTION

(76) Inventor: Kuo-Lung CHANG, Junghe City (TW)

Correspondence Address: SINORICA, LLC, 528 FALLSGROVE DRIVE, ROCKVILLE, MD, 20850, US

(21) Appl. No.: 11/563,063

(22) Filed: Nov. 24, 2006

(30) Foreign Application Priority Data
Aug. 8, 2006 (TW) 95128945

(51) Int. Cl. G09G 3/28; H04N 7/16; G06F 15/16

(52) U.S. Cl. 725/141; 345/70; 709/246

(57) ABSTRACT

A removable apparatus with a plug-and-show function is applied to a wireless presentation system. The wireless presentation system includes a computer and a wireless gateway. The computer is capable of displaying plural presentation frames. The wireless gateway provides ability in wireless network connection. When the removable apparatus connects with the computer, the removable apparatus can automatically analyze the difference region between the current presentation frame displaying in the computer and the preceding presentation frame. The difference region is captured as an update image to be forwarded to the wireless gateway through the computer. The wireless gateway then reproduces a presentation frame the same as the current presentation frame in the computer by integrating the update image with the preceding presentation frame. The reproduced presentation frame is then output to a display device for further displaying.

### BACKGROUND OF THE INVENTION

(1) Field of the Invention

The invention relates to a removable apparatus, and more particularly to the removable apparatus with a plug-and-show function, which the removable apparatus is applied to a wireless presentation system.

(2) Description of the Prior Art

Referring to FIG.1, a block diagram of a conventional wireless presentation system is shown. A wireless gateway 1 is connected with a display device 2 at the display end. The display device 2 can be a projector, a plasma TV or any the like. The wireless gateway 1 provides the system connection and data accessing to a wireless network. At the user end of the system, a computer 3 capable of displaying presentation frames is introduced. The presentation frames shown on the computer 3 can be wireless forwarded to the wireless gateway 1, and further to the display device 2.

The wireless presentation system mainly forwards the presentation frames through the wireless network. Merits thereby include better mobility to the user, less wiring work, and so on. Due to tremendous data transmission required in a presentation, the transmission speed may be too slow to degrade the presentation quality while using the wireless network to transmit data. To improve such a shortcoming, a mirror driver is usually applied to the computer at the user end. The role and functions of the mirror driver in the wireless presentation system will be described as follows.

In a presentation, some correlations usually exist in consequent presentation frames. For example, they may apply the same background or the same color system. That is to say that a presentation frame usually resemble its preceding or following frame; especially when descriptions and animations are included in these presentation frames. At this time, the mirror driver is used to analyze the difference between presentation frames and to capture the new image of the next presentation frame from the computer. The new image is then forwarded to the wireless gateway through the wireless network. The wireless gateway updates the new image to the current presentation frame so as to produce a new presentation frame thereinside. The new presentation frame is then output to the display device for presentation.

Though the mirror driver may reduce the transmission volume of the presentation system and thus increase the transmission speed as well as the presentation quality, yet following disadvantages still exist.

a. A complete installation of the mirror driver to the computer is needed before it can be used in helping the data transmission. Such an installation usually takes a lot of time.

b. Because the installation of the mirror driver is required in advance and because most of companies usually apply strict internal control in computer usage, the lousy application process leading to a successful usage of the mirror driver usually inhibits the employee to do so.

c. As the wireless presentation system become popular, compatibility between various wireless gateways and mirror drivers becomes an issue. It is usually a limitation that a wireless gateway can only go with a mirror driver produced by the same manufacturer.

In the art, before a presentation can be held, the presentation material is generally stored in a removable apparatus such as a USB flash disk. The removable apparatus is then plugged into the computer for presentation. In general, a plug-and-show application is expected to the usage of the removable apparatus. However, limited by the requirement of the mirror driver, the chore from installing the mirror driver before displaying the presentation material usually cause inconvenience to the usage of the wireless presentation system.

Therefore, how to overcome the aforesaid shortcomings in using the wireless presentation system becomes one of urgent topics to the skilled person in this art.

### SUMMARY OF THE INVENTION

Accordingly, it is an object of the present invention to provide a removable apparatus with a plug-and-show function. As soon as the removable apparatus connects with the computer carrying the wireless presentation system, the presentation frames can be displayed directly.

It is another object of the present invention to provide a wireless presentation system that connects with the removable apparatus to display the presentation frames in a plug-and-show pattern.

It is a further object of the present invention to provide a method for the removable apparatus to perform the plug-and-show displaying.

In the present invention, the removable apparatus with a plug-and-show function is applied to a wireless presentation system. The wireless presentation system includes a computer, a wireless gateway and a display device. The removable apparatus includes a wireless network detecting module, a memory, an image capturing and analyzing module, and a plug-and-show module.

The wireless network detecting module includes thereinside an extended service set identifier (ESSID) of the wireless gateway. When the removable apparatus connects with the computer, the wireless network detecting module can detect surrounding wireless network signals and, if the wireless network signals exist, a wireless network connection between the removable apparatus and the wireless gateway can be established in accordance with the ESSID.

The memory for storing the plural presentation frames can further include a buffer for temporarily storing the current presentation frame (the N-th presentation frame) displaying in the computer and the preceding presentation frame (the N−1-th presentation frame).

The image capturing and analyzing module can perform an image capturing and analyzing process to locate difference regions between the N-th presentation frame and the N−1-th presentation frame. The difference regions in the N-th presentation frame can be read as an integral update image which can be a rectangular area including those difference regions.

The plug-and-show module is mainly to control the image capturing and analyzing module in performing the image capturing and analyzing process and to further forward the update image to the wireless gateway through the computer, when the removable apparatus connects with the computer. In order to reduce the transmission load of the wireless network and to raise the transmission speed, the update image can be zipped in advance.

After the wireless gateway receives the zipped update image, an unzipping process is firstly applied to the zipped update image so as to integrate the update image into the N−1-th presentation frame inside the wireless gateway to further produce a new presentation frame identical exactly with the N-th presentation frame of the computer. The new presentation frame (namely the N-th presentation frame) is then output to the display device for broadcasting.

In the present invention, a wireless presentation method by using the removable apparatus includes the steps of: a. connecting a removable apparatus storing plural presentation frames to a computer; b. controlling the computer to establish a wireless connection with a wireless gateway; c. displaying the N-th presentation frame in the computer; d. performing an image capturing and analyzing process to locate a difference region between the N-th presentation frame and the N−1-th presentation frame and further to capture an update image corresponding to the difference region at the N-th presentation frame; e. forwarding the update image to the wireless gateway through the computer; f. integrating the update image with the N−1-th presentation frame to reform the N-th presentation frame inside the wireless gateway; g. forwarding the reformed N-th presentation frame of the wireless gateway to a display device; h. determining if or not all the presentation frames have been displayed; i. if negative, assigning N+1 to replace N and to repeat step c; and j. if positive, terminating the display of the presentation frames.

All these objects are achieved by the removable apparatus with a plug-and-show function described below.

### BRIEF DESCRIPTION OF THE DRAWINGS

The present invention will now be specified with reference to its preferred embodiment illustrated in the drawings, in which:

FIG. 1 is a schematic block diagram of a conventional wireless presentation system;

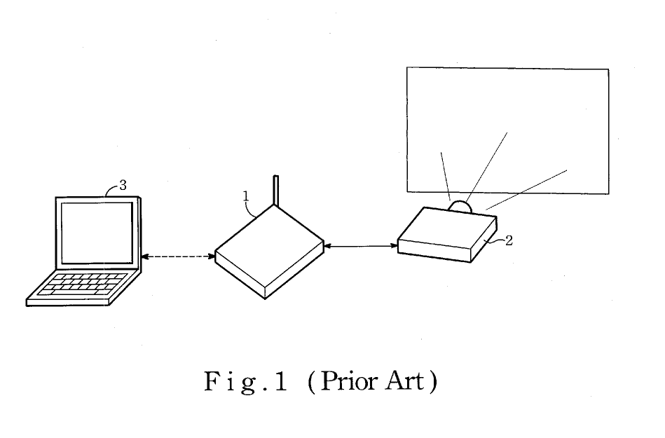

FIG. 2 shows a relationship between a preferred removable apparatus with a plug-and-show function in accordance with the present invention and a wireless presentation system;

FIG. 3 is a flowchart of a preferred wireless presentation method by using the removable apparatus of the present invention; and

FIG. 4 is a schematic view showing how an image capturing and analyzing module of the present invention performs an image capturing and analyzing process.

### DESCRIPTION OF THE PREFERRED EMBODIMENT

The invention disclosed herein is directed to a removable apparatus with a plug-and-shown function. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In the present invention, the removable apparatus is usually applied to a wireless presentation system. By providing the removable apparatus to connect with the wireless presentation system, a plug-and-show type of presentation show can be held immediately.

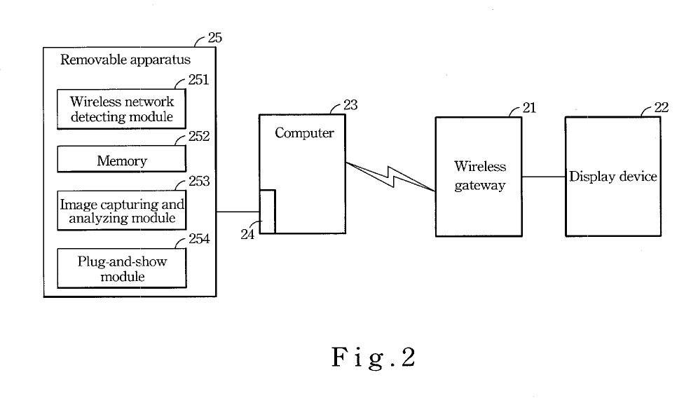

Referring now to FIG. 2, a relationship between a preferred removable apparatus with a plug-and-show function in accordance with the present invention and a wireless presentation system is shown in this block diagram.

As shown, the wireless presentation system includes, at the display end, a wireless gateway 21 and a display device 22 such as a projector, a plasma TV, or any the like. The wireless gateway 21 connected with the display device 22 can provide connection and data accessing to the wireless network. At the user end of the wireless presentation system, a computer 23 capable of displaying presentation frames is included. The computer 23 has a transmission port 24 such as a USB interface. The removable apparatus of the present invention can be a USB portable disk capable of forming a plug-and-show connection with the transmission port 24 of the computer 23.

The removable apparatus 25 includes a wireless network detecting module 251, a memory 252, an image capturing and analyzing module 253, and a plug-and-show module 254.

The wireless network detecting module 251 includes thereinside an extended service set identifier (ESSID) of the wireless gateway 21. When the removable apparatus 25 connects with the computer 23, the wireless network detecting module 251 can detect surrounding wireless network signals and, if the wireless network signals exist, a wireless network connection between the removable apparatus 25 and the wireless gateway 21 can be established in accordance with the ESSID.

The memory 252 for storing a plurality of presentation frames can further include a buffer for temporarily storing the current presentation frame (the N-th presentation frame) displaying in the computer 23 and the preceding presentation frame (the N−1-th presentation frame).

The image capturing and analyzing module 253 can perform an image capturing and analyzing process to locate difference regions (at least one difference region) between the N-th presentation frame and the N−1-th presentation frame. The difference regions in the N-th presentation frame can be read as an integral update image which can be a rectangular area including those difference regions.

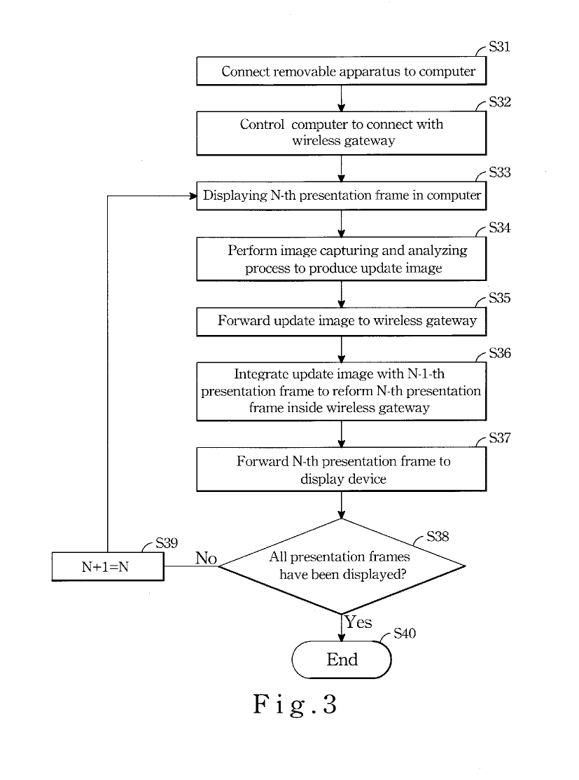

Referring now to FIG. 3, a flowchart of a preferred wireless presentation method by using the removable apparatus of the present invention is shown. The wireless presentation method by using the removable apparatus includes the steps of: connecting a removable apparatus storing plural presentation frames to a computer (S31); controlling the computer to establish a wireless connection with a wireless gateway (S32); displaying the N-th presentation frame in the computer (S33); performing an image capturing and analyzing process to locate at least a difference region between the N-th presentation frame and the N−1-th presentation frame and further to capture an update image corresponding to the difference region at the N-th presentation frame (S34); forwarding the update image to the wireless gateway through the computer (S35); integrating the update image with the N−1-th presentation frame to reform the N-th presentation frame inside the wireless gateway (S36); forwarding the reformed N-th presentation frame of the wireless gateway to a display device (S37); determining if or not all the presentation frames have been displayed (S38); if negative, assigning N+1 to replace N (S39) and further to repeat step S33; and, if positive, terminating the display of the presentation frames (S40).

In step S34, when N=1, the 0-th presentation frame can be a blank frame or a preset frame. Further, between the N-th presentation frame and the N−1-th presentation frame, either a single one difference region or a plurality of difference regions may be possible. Also, the number of the update image may be more than one. However, the update image is a rectangular area containing the difference region.

In step S35, before it is forwarded to the wireless gateway, the update image is zipped in advance so as to reduce the transmission load of the wireless network. Similarly, in step S36, as soon as the wireless gateway receives the zipped update image, an unzipping process is firstly applied to the zipped update image before the update image can be integrated into the N−1-th presentation frame inside the wireless gateway.

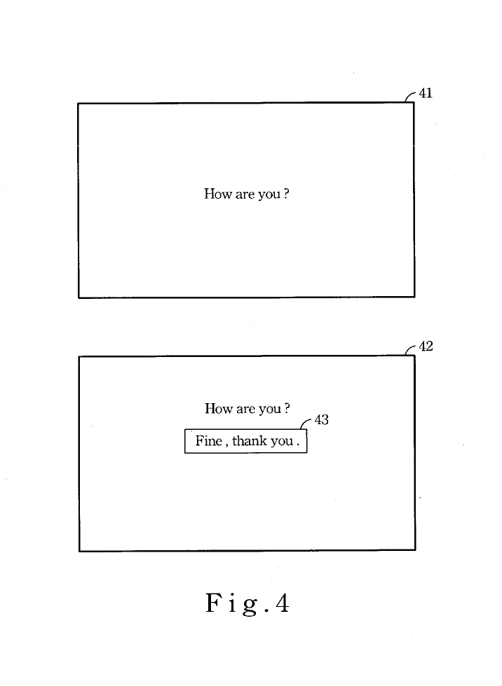

Referring now to FIG. 4, a schematic view showing how an image capturing and analyzing module of the present invention performs an image capturing and analyzing process is present. As shown, the N−1-th presentation frame 41 and the N-th presentation frame 42 are included. The N−1-th presentation frame 41 includes captions [symbol] How are you? [symbol] while the N-th presentation frame 42 includes captions of [symbol] How are you? [symbol] and [symbol] Fine, thank you. [symbol] 43.

At this time, an exclusive-or (XOR) operation can be applied to locate the difference regions between the two presentation frames 41 and 42. Apparently, in this example, the difference region is the [symbol] Fine, thank you. [symbol] Further, the update image 43 formed by a rectangular area in the N-th presentation frame 42 is retrieved from the N-th presentation frame. Preferably, the rectangular area 43 can be the least-area rectangle containing the difference region.

By providing the removable apparatus with a plug-and-show function of the present invention, a presentation or a film show can be simply begun by plugging the removable apparatus into the computer of the wireless presentation system. By compared to the convention technique, the present invention does not need to install any mirror driver in advance. Therefore, by utilizing the removable apparatus of the present invention, the operation of the presentation can be made much easier, the display of the presentation materials won't affect the normal usage of the computer after displaying the presentation materials, and the situation that the mirror driver may be loaded to bother the computer will never happen.

While the present invention has been particularly shown and described with reference to a preferred embodiment, it will be understood by those skilled in the art that various changes in form and detail may be without departing from the spirit and scope of the present invention.

I claim:

1. A removable apparatus with a plug-and-show function, applied to a wireless presentation system having a computer and a wireless gateway, the computer being capable of displaying a plurality of presentation frames and wireless connecting to the wireless gateway, the removable apparatus being capable of establishing a removable connection with the computer, the removable apparatus comprising:
a memory for storing an N-th presentation frame and an N−1-th presentation frame;
an image capturing and analyzing module for locating at least difference region between the N-th presentation frame and the N−1-th presentation frame and for further capturing an update image corresponding to the difference region at the N-th presentation frame; and
a plug-and-show module for controlling the image capturing and analyzing module in performing an image capturing and analyzing process and for further forwarding the update image to the wireless gateway through the computer;
wherein, after the wireless gateway receives the update image, the update image is integrated with the N−1-th presentation frame inside the wireless gateway so as to reproduce the N-th presentation frame inside the wireless gateway.

2. The removable apparatus according to claim 1, wherein said wireless presentation system further includes a display device connected with said wireless gateway and used for displaying said presentation frames output from said wireless gateway.

3. The removable apparatus according to claim 1, wherein said computer has a transmission port for establishing said removable connection with said removable apparatus.

4. The removable apparatus according to claim 3, wherein said transmission port is a USB transmission interface and said removable apparatus is a USB portable disk.

5. The removable apparatus according to claim 1, further including a wireless network detecting module for detecting wireless signals of said wireless gateway and for controlling wireless connection between said computer and said wireless gateway, when said removable apparatus connects with said computer.

6. A wireless presentation system, comprising:
a computer for displaying a plurality of presentation frames;
a wireless gateway capable of wireless connecting with the computer and further receiving the presentation frames forwarded from the computer; and
a removable apparatus, forming a removable connection with the computer, comprising:
a memory for storing an N-th presentation frame and an N−1-th presentation frame;
an image capturing and analyzing module for locating at least difference region between the N-th presentation frame and the N−1-th presentation frame and for further capturing an update image corresponding to the difference region at the N-th presentation frame; and
a plug-and-show module for controlling the image capturing and analyzing module in performing an image capturing and analyzing process and for further forwarding the update image to the wireless gateway through the computer;
wherein, after the wireless gateway receives the update image, the update image is integrated with the N−1-th presentation frame inside the wireless gateway so as to reproduce the N-th presentation frame inside the wireless gateway.

7. The wireless presentation system according to claim 6, further including a display device connected with said wireless gateway and used for displaying said presentation frames output from said wireless gateway.

8. The wireless presentation system according to claim 6, wherein said computer has a transmission port for establishing said removable connection with said removable apparatus.

9. The wireless presentation system according to claim 8, wherein said transmission port is a USB transmission interface and said removable apparatus is a USB portable disk.

10. The wireless presentation system according to claim 6, wherein said removable apparatus further includes a wireless network detecting module for detecting wireless signals of said wireless gateway and for controlling wireless connection between said computer and said wireless gateway, when said removable apparatus connects with said computer.

11. A wireless presentation method by using a removable apparatus, comprising the steps of:
a. connecting the removable apparatus storing plural presentation frames to a computer;
b. controlling the computer to establish a wireless connection with a wireless gateway;
c. displaying an N-th presentation frame in the computer;
d. performing an image capturing and analyzing process to locate at least a difference region between the N-th presentation frame and an N−1-th presentation frame and further to capture an update image corresponding to the difference region at the N-th presentation frame;
e. forwarding the update image to the wireless gateway through the computer;
f. integrating the update image with the N−1-th presentation frame to reform the N-th presentation frame inside the wireless gateway;
g. forwarding the reformed N-th presentation frame of the wireless gateway to a display device;
h. determining if or not all the presentation frames have been displayed; and
i. if negative, assigning N+1 to replace N and further to repeat step c;
otherwise, terminating the display of the presentation frames.

12. The wireless presentation method according to claim 11, wherein said removable apparatus includes thereinside an extended service set identifier (ESSID) of said wireless gateway, said computer connecting with said wireless gateway through the ESSID.

13. The wireless presentation method according to claim 11, wherein said step d uses an exclusive-or (XOR) operation to locate said difference region between said N-th presentation frame and said N−1-th presentation frame.

14. The wireless presentation method according to claim 11, wherein said update image of said step d is a rectangular area containing said difference region.

15. The wireless presentation method according to claim 11, wherein said update image of said step e is zipped in advance before being forwarded to said wireless gateway through said computer.

16. The wireless presentation method according to claim 15, wherein said update image of said step f is unzipped in advance before being integrated with said N−1-th presentation frame.
